(19) United States
(12) Patent Application Publication
(10) Pub. No.: US 2003/0089089 A1
(43) Pub. Date: May 15, 2003

(54) Respirator filter element

(76) Inventors: Keith E. Fecteau, Wilbraham, MA (US); Don Seeto, Framingham, MA (US)

Correspondence Address: CANTOR COLBURN, LLP, 55 GRIFFIN ROAD SOUTH, BLOOMFIELD, CT, 06002

(21) Appl. No.: 09/999,856

(22) Filed: Oct. 31, 2001

(51) Int. Cl. B01D 46/00

(52) U.S. Cl. 55/497; 55/521

(57) ABSTRACT

A filtration element of a respirator or breathing mask including rear and front walls and a pleated separating layer that is not coextensive with the walls. The pleated separating layer maintains the front and rear walls in a spaced-apart relationship resulting in high filtration performance and reduced breathing resistance.

### BACKGROUND

Filtration elements are commonly used in respirators or face masks to remove aerosol particles or filter noxious vapors and gases from the air in order to protect the user's respiratory system. Filtration elements typically incorporate materials that maximize filter surface area and that minimize obstruction of the user's vision. Additionally, filtration elements are designed to manage air flow and make breathing through the filtration device easy for the user. Management of air flow and facilitation of easy breathing through respirators or face masks remains a significant problem.

U.S. Pat. No. Re. 35,062 to Brostrom discloses a filter element, compact in size, with a front and rear wall 6, 7 and a layer of non-woven, porous material in between referred to as a baffle component 8 (see Prior Art FIG. 1). Brostrom discloses use of a baffle component 8 containing multiple layers. The baffle component 8 and the front and rear walls 6, 7 are substantially coextensive with each other and are bonded at their peripheral edges 9. The porosity of baffle component 8 provides void air space between the front and rear walls 6, 7 and the material of the baffle component 8 serves to space apart the front and rear walls 6, 7 such that air flow resistance is otherwise lowered. Brostrom provides a solution offering somewhat lowered breathing resistance, however, there is much room for improvement, particularly for applications that require prolonged use of respirator filter elements.

### SUMMARY

The above-discussed problems and deficiencies of the prior art are overcome or alleviated by the present filtering element. One aspect of the present filter element includes a front wall, a rear wall and a non-coextensive pleated separating layer therebetween, which maintains the walls in a spaced configuration. In an exemplary aspect, the pleated separating layer comprises a single layer of material, which maintains the front and rear walls in a spaced configuration. These configurations significantly reduce breathing resistance and increase performance of the filer element.

The above-discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in several FIGURES:

PRIOR ART FIG. 1 is a partial rear cross-sectional view a prior art filter element;

FIG. 2 is a rear aspect view of an exemplary embodiment of a filter element;

FIG. 3 is a partial rear cross-sectional view of the filter element of FIG. 2;

FIG. 4 is a cross-sectional view of the filter element of FIG. 2 taken along line A-A;

FIG. 5 is a rear aspect view of an exemplary embodiment of a filter element; and

FIG. 6 is a cross-sectional view of the filter element of FIG. 5 taken along line A′-A′.

### DESCRIPTION OF EXEMPLARY EMBODIMENT

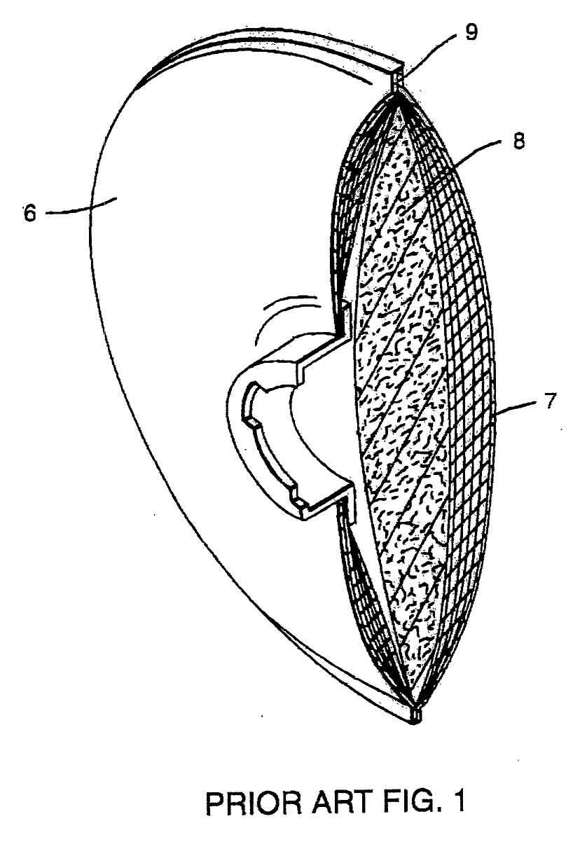

Referring now to FIG. 2, an exemplary filter element is shown generally at 10, including rear wall 12 with opening 14 offset from a center portion of the filter element. Within the opening 14 is a fitting 16, which may be respirator breathing tube or other connector facilitating connection to a respirator (not shown). The fitting 16 is shown generally attached to the rear wall 12 of the filter element. Such attachment may be by any means known in the art, including various bonding methods, such as adhesive, thermal or ultrasonic welding, among others. The fitting may attach to the internal and/or external surfaces of the rear wall 12.

Within opening 14, the interior of the filter element 10 can be seen, including pleated separating layer 18. The opening 14 and fitting 16 provide the breathing tube access to the interior space of the filter element. While an exemplary embodiment is illustrated and described, other respirator filter element configurations are contemplated. For example, while a round rear and front wall 12, 20 circumference is illustrated, the respirator filter element may take on an number of alternate shapes, such as oval or square, among others. Similarly, placement and size of the fitting 16 may be varied according to the desired application.

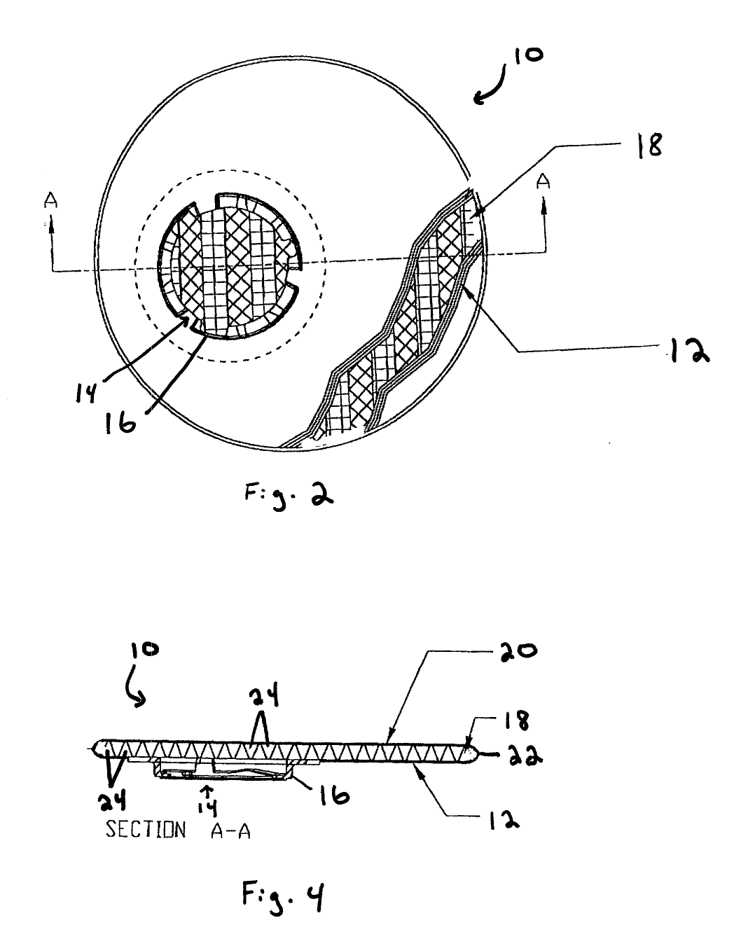

Referring now to FIG. 3, the filter element is illustrated by a rear, cross-sectional view. The respirator filter element 10 includes a rear wall 12, an opening 14, a fitting 16, a pleated separating layer 18, and a front wall 20. In an exemplary embodiment, the rear and front walls 12, 20 are sealed together along their peripheral edges. As shown in the exemplary embodiment, the pleated separating layer 18 comprises a single layer of material. As will be discussed more fully below, the single-layer pleated separating layer 18 provides the lowest breathing resistance relative to prior art, multiple-layer, non-pleated separators and is accordingly preferred. Referring still to FIG. 3, it can be seen that the pleated separating layer 18 effectively maintains the rear wall 12 and front wall 20 in a spaced apart configuration with minimal structure, ensuring that substantial airspace exists between the rear and front walls 12, 20. As will be illustrated by the TABLE below, this pleated configuration substantially and advantageously reduces breathing resistance across the filter element.

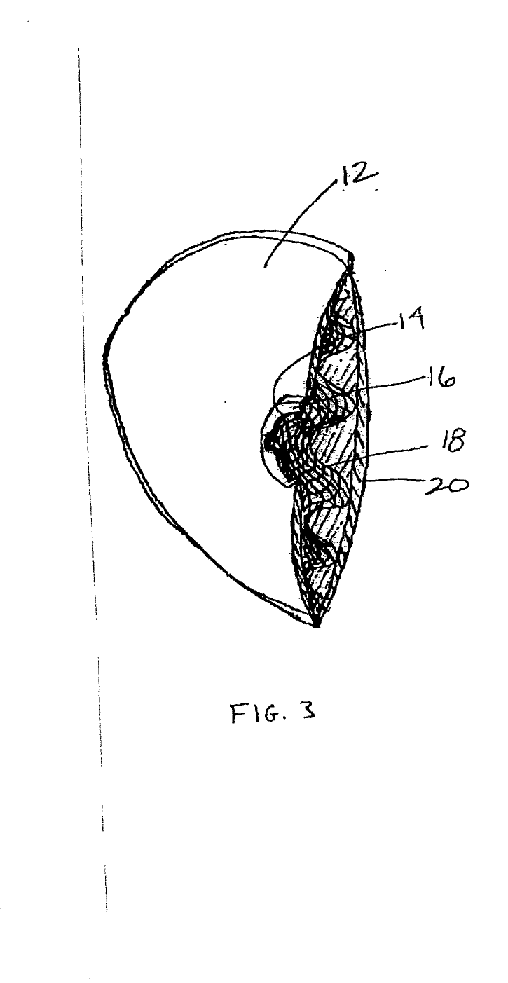

Referring now to FIG. 4, a cross-section of an exemplary filter element is shown, further illustrating the preferred pleated configuration. As in FIG. 3, the respirator filter element 10 includes a rear wall 12, front wall 20, opening 14, fitting 16, and pleated separating layer 18. As is exemplified, the rear wall 12 and front wall 20 are shown to be coextensive and bonded together at circumferential edges 22. The exemplified pleated separating layer 18 is shown in a non-coextensive configuration relative to the rear and front walls 12, 20. The exemplary non-coextensive pleated separating layer provides superior performance of the filter element by allowing air to pass through both the rear and front walls of the filter element, along the channels 24 created by the pleated separating layer 18, through the opening 14 and into the respirator.

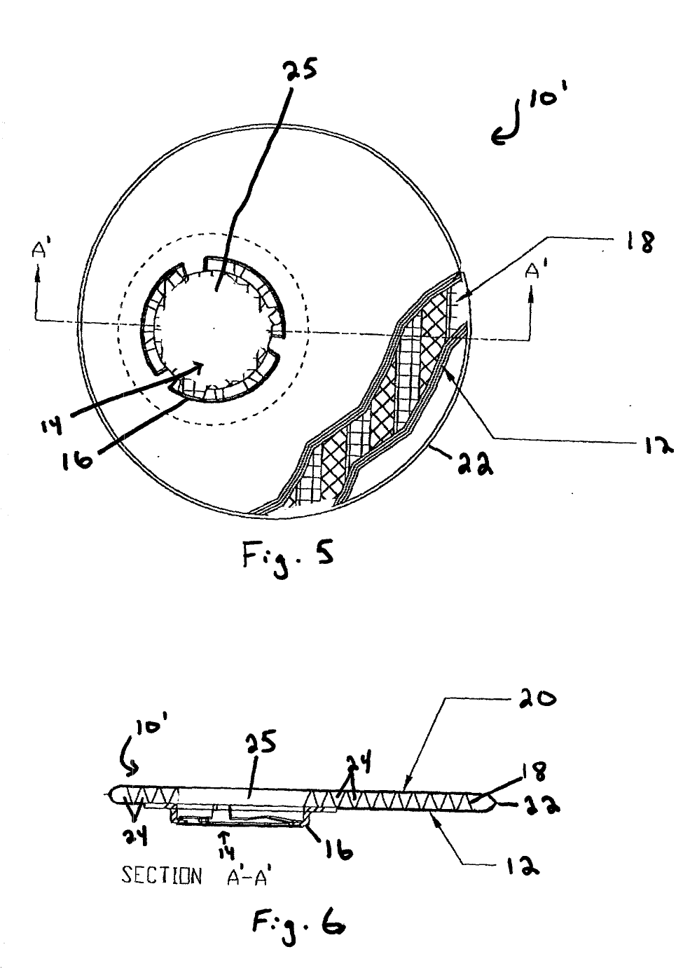

Referring now to FIGS. 5 and 6, a front corner perspective cutaway view of an exemplary filter element is illustrated. The respirator filter element 10 includes a rear wall 12, front wall 20, opening 14, fitting 16, and pleated separating layer 18. As is exemplified, the rear wall 12 and front wall 20 are shown to be coextensive and bonded together at circumferential edges 22. The exemplified pleated separating layer 18 is shown in a non-coextensive configuration relative to the rear and front walls 12, 20. The exemplary non-coextensive pleated separating layer further includes a hole or relief 25 generally proximate to the opening 14. The illustrated exemplary separating layer configuration maximizes performance by allowing air to pass through both the rear and front walls of the filter element, along the channels 24 created by the pleated separating layer 18, through the opening 14 and into the respirator while at the same time providing a low-density interior space maintained by the pleated separating layer.

While exemplary embodiments are illustrated and described, other respirator filter element configurations are contemplated. For example, the pleated separating layer 18 may be coextensive with the rear and front walls 12, 20 and sealed along with the circumferential edges 22 of the rear and front walls. The pleated separating layer also need not conform to the circumferential dimensions of the rear and front walls 12, 20. For example, the rear and front walls 12, 20 are generally oval while the pleated separating layer may be generally round. Also, the size, number and configuration of the pleats within the separating layer 18 may be varied according to the desired application.

Exemplary materials for the rear and front walls 12, 20 will vary depending upon the type of substance the respirator or breathing mask is intended to filter. As is known in the art, the material may include single or multiple layers of non-woven web, fibrillated film web, air-laid web, sorbent particle-loaded fibrous web such as those described in U.S. Pat. No. 3,971,373 to Braun, glass filter paper, or a mixture of two or more of the foregoing materials. Exemplary materials for the fitting 16 include plastic or metal, among others, such as are known in the art to be suitable for a breathing tube or other connector. Exemplary materials for the pleated separating layer 18 include flexible materials, such as woven, non-woven or solid plastic films, among others. An exemplary pleated separating layer comprises a single-layer thick plastic film. Another exemplary pleated separating layer comprises a single layer woven mesh.

TABLE 1 illustrates how pleating of a single separating layer accomplishes significantly reduced breathing resistance for the respirator filter element. The following TABLE demonstrates the change in pressure (ΔP (millimeters H₂O @ 42.5 liters per minute of air flow)) across the filter and separating layer element for woven, non-woven and solid separating layers, both flat and pleated, coextensive and non-coextensive:

TABLE 1

| Co- | | Ma- | | | ΔP (mm H2O @ |
|---|---|---|---|---|---|
| extensive | | terial | % | Number of | 42.5 lpm air |
| (yes/no) | Form | Type | Solidity | Layers | flow) |
| Yes | Flat | Woven | 30 | 1 | 48 |
| Yes | Pleated | Woven | 30 | 1 | 24 |
| No | Flat | Woven | 30 | 1 | 46 |
| No | Pleated | Woven | 30 | 1 | 24 |
| Yes | Flat | Non- | 20 | 1 | 128 |
| | | woven | | | |
| Yes | Pleated | Non- | 20 | 1 | 27 |
| | | woven | | | |
| No | Flat | Non- | 20 | 1 | 129 |
| | | woven | | | |
| No | Pleated | Non- | 20 | 1 | 27 |
| | | woven | | | |
| Yes | Flat | Solid | 100 | 1 | >150 |
| Yes | Pleated | Solid | 100 | 1 | 88 |
| No | Flat | Solid | 100 | 1 | >150 |
| No | Pleated | Solid | 100 | 1 | 48 |

Referring now to TABLE 1, it can be seen that non-coextensive, woven, pleated separating layers provide the least pressure change across the filter element, and thus provide the lowest breathing resistance. It can also be seen that pleating the separating layer enhances filter element performance across the board by lowering breathing resistance independent of other factors, including material type, layer thickness, percent solidity and fiber diameter.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A filter element comprising:
rear and front walls joined to each other along peripheral edges;
a pleated separating layer non-coextensive with the front and rear walls contained within an interior space between the walls.

2. The filter element of claim 1 wherein the filter element is round.

3. The filter element of claim 1 wherein the front and rear walls and the pleated separating layer are joined together along their peripheral edges.

4. The filter element of claim 1 wherein the rear and front walls each comprise at least one layer of a filter material, and the rear wall, including the layer of filter material, having an opening that provides access to the interior space defined by the rear and front walls.

5. The filter element of claim 3 wherein the opening includes a fitting attached to the internal surface of the rear wall.

6. The filter element of claim 1 wherein the pleated separating layer is a single layer.

7. The filter element of claim 1 wherein the pleated separating layer is solid.

8. The filter element of claim 1, wherein the pleated separating layer includes at least one hole or relief formed therein.

9. The filter element of claim 8, wherein at least one hole or relief is proximate to an opening in one of the front and rear walls.

10. A filter element comprising
rear and front walls joined to each other along their peripheral edges;
a pleated separating layer coextensive with and contained between the front and rear walls.

11. A filter element of claim 10 wherein the rear and front walls each comprise at least one layer of a filter material, and the rear wall, including said layer of filter material, having an opening that provides access to the interior space defined by the rear and front walls.

12. The filter element of claim 11, wherein the opening includes a fitting attached to the internal surface of the rear wall.

13. The filter element of claim 10 wherein the pleated separating layer is a single layer.

14. The filter element of claim 10 wherein the pleated separating layer is solid.

15. The filter element of claim 10, wherein the pleated separating layer includes at least one hole or relief formed therein.

16. The filter element of claim 15, wherein at least one hole or relief is proximate to an opening in one of the front and rear walls.
